(19) United States
(12) Patent Application Publication
(10) Pub. No.: US 2022/0188882 A1
(43) Pub. Date: Jun. 16, 2022

(54) LEAVING HIERARCHICAL-EMBEDDED REVIEWS FOR VERIFIED TRANSACTIONS

(71) Applicant: International Business Machines Corporation, Armonk, NY (US)

(72) Inventors: Thai Quoc Tran, San Jose, CA (US); Cindy Han Lu, San Jose, CA (US); Animesh Singh, Santa Clara, CA (US); Srinivas R. Brahmaroutu, San Jose, CA (US)

(21) Appl. No.: 17/117,664

(22) Filed: Dec. 10, 2020

(51) Int. Cl. G06Q 30/02; G06K 19/06; G06K 7/14; G06Q 20/32; G06Q 20/40

(52) U.S. Cl. CPC G06Q 30/0282; G06K 19/06037; G06Q 20/401; G06Q 20/3276; G06K 7/1417

(57) ABSTRACT

A method for leaving hierarchical-embedded reviews for verified transactions comprising: (i) receiving a first provider entity data set; (ii) creating a first provider portion of a first graph data structure; (iii) creating a first customer entity node in the first graph data structure; (iv) receiving a new transaction data set including information indicative of a business transaction between the first customer entity and a first provider sub-entity of the plurality of sub-entities; (v) creating a new transaction node in the first graph data structure, with the new transaction node including data from the first new transaction data set; (vi) creating a pairwise connection in the first graph data structure between the new transaction node and the lower level node corresponding to the first provider sub-entity; and (vii) creating a pairwise connection in the first graph data structure between the new transaction node and the first customer entity node.

### BACKGROUND

The present invention relates generally to the field of customer reviews entered and distributed by computers and over a communication network, and also to the field of quick response (QR) codes.

The Wikipedia entry for “QR code” (as of 4 Nov. 2020) states as follows: “A QR code (abbreviated from Quick Response code) is a type of matrix barcode (or two-dimensional barcode) first designed in 1994 for the automotive industry in Japan. A barcode is a machine-readable optical label that contains information about the item to which it is attached. In practice, QR codes often contain data for a locator, identifier, or tracker that points to a website or application. A QR code uses four standardized encoding modes (numeric, alphanumeric, byte/binary, and kanji) to store data efficiently; extensions may also be used. The Quick Response system became popular outside the automotive industry due to its fast readability and greater storage capacity compared to standard UPC barcodes. Applications include product tracking, item identification, time tracking, document management, and general marketing. A QR code consists of black squares arranged in a square grid on a white background, which can be read by an imaging device such as a camera, and processed using Reed-Solomon error correction until the image can be appropriately interpreted. The required data is then extracted from patterns that are present in both horizontal and vertical components of the image.” (footnotes omitted)

The Wikipedia entry for “user review” (as of 4 Nov. 2020) states as follows: “A user review is a review conducted by any person who has access to the internet and publishes their experience to a review site or social media platform following product testing or the evaluation of a service. User reviews are commonly provided by consumers who volunteer to write the review, rather than professionals who are paid to evaluate the product or service. User reviews might be compared to professional nonprofit reviews from a consumer organization, or to promotional reviews from an advertiser or company marketing a product. Growth of social media platforms has enabled the facilitation of interaction between consumers after a review has been placed on online communities such as blogs, internet forums or other popular platforms . . . . User reviews guide stakeholders, including consumers, producers, and competitors decision making process regarding the good or service experienced by the user providing the review. Purchase decisions can be made with easy access to product information through reviews from users who have knowledge from an experience, information or tangible good. Producers of goods and services can utilize user reviews through word of mouth (WOM) recognition enhancing their reputation, but can also be disparaged. For goods which value is derived from knowledge and information, user reviews provide a “wealth of experience information,” and therefore increase potential consumers . . . . User reviews are seen as a ‘driving force’ in marketing, in direct correlation with sales of a good or service. Positive user reviews of a good or service are likely to increase demand of the product through positive attitudes and behavior toward the company. Research has shown that negative user reviews have a more widespread impact than positive.” (footnotes omitted)

### SUMMARY

According to an aspect of the present invention, there is a method, computer program product and/or system that performs the following operations (not necessarily in the following order): (i) receives a first provider entity data set that identifies: (a) a first provider entity, and (b) a plurality of sub-entities that are respectively considered as portions of the first provider entity; (ii) creates a first provider portion of a first graph data structure, with the first provider portion of the first graph data structure including: (a) a root level node corresponding to the first provider entity, (b) lower level nodes respectively corresponding to the sub-entities of the first provider entity, and (c) hierarchical connections among and between the root level node and the lower level nodes so that the first provider portion of the first graph forms a tree structure; (iii) creates a first customer entity node in the first graph data structure; (iv) receives a new transaction data set including information indicative of a business transaction between the first customer entity and a first provider sub-entity of the plurality of sub-entities; (v) creates a new transaction node in the first graph data structure, with the new transaction node including data from the first new transaction data set; (vi) creates a pairwise connection in the first graph data structure between the new transaction node and the lower level node corresponding to the first provider sub-entity; and (vii) creates a pairwise connection in the first graph data structure between the new transaction node and the first customer entity node.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a diagram of a graph data structure generated by the first embodiment system;

FIG. 5 is a diagram of a graph data structure generated by a second embodiment of the present invention; and

FIG. 6 is a screen shot of a visual user interface for entering customer reviews and/or other information related to a transaction.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

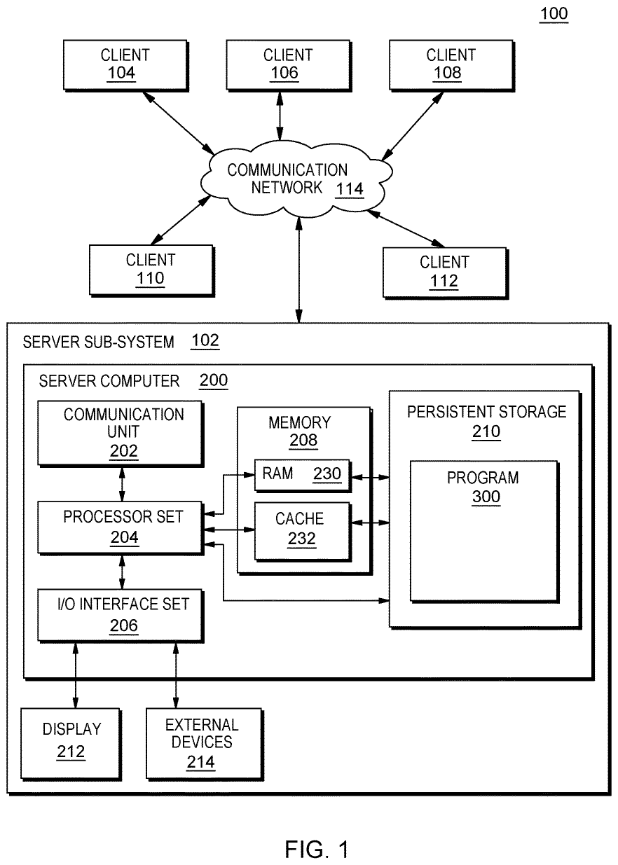

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

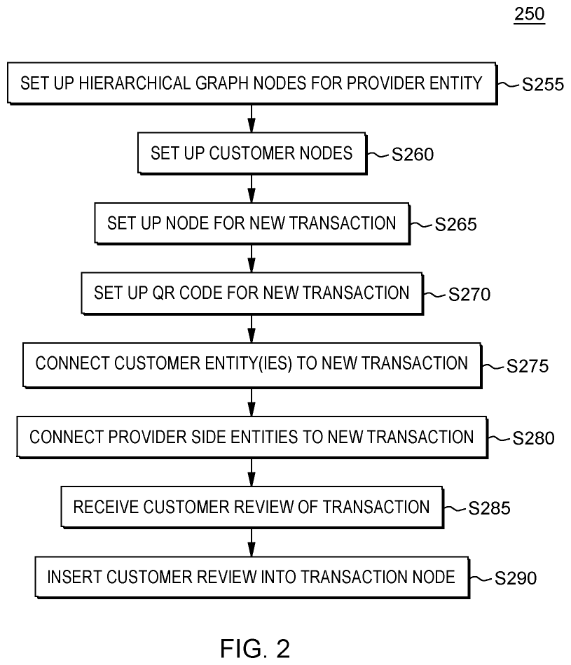

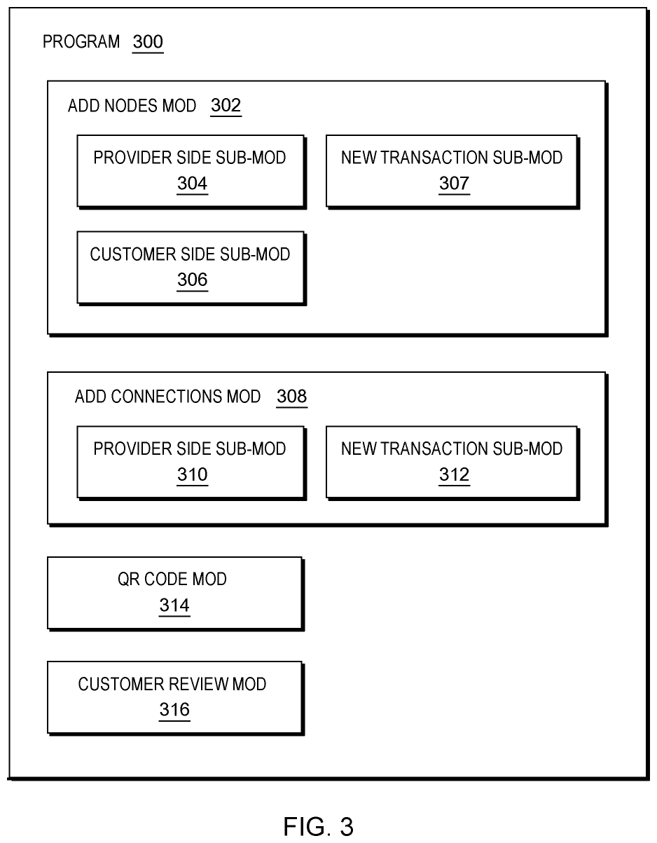

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

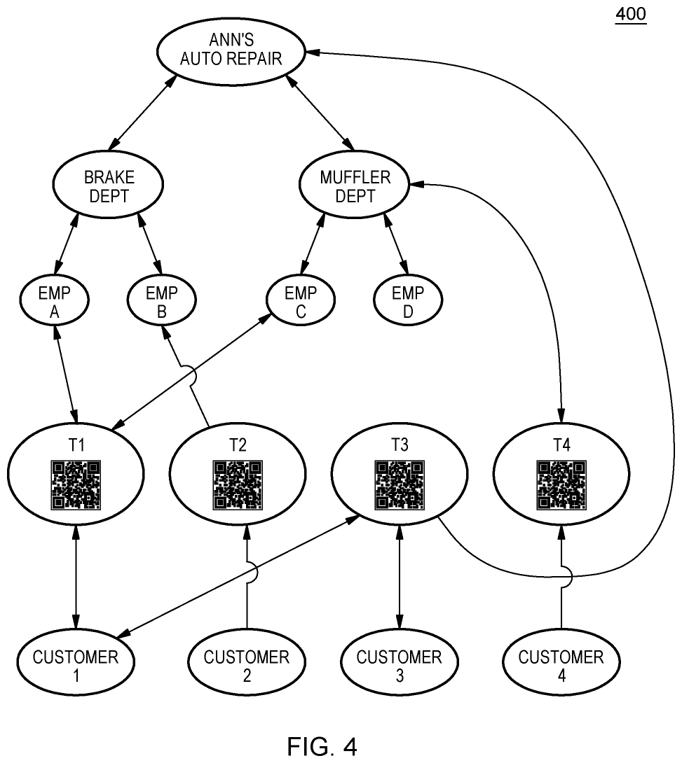

Processing begins at operation S255, where add nodes module (“mod”) 302 and add connections mod 308 work cooperatively to start the construction of graph data structure 400 (see FIG. 4) by setting up a portion of the graph corresponding to a provider entity. Roughly speaking, the provider entity is an entity that provides good(s) and/or service(s), of any sort, to customers. In the example of graph 400, the provider entity is an incorporated business called “Ann's Auto Repair.” The node labelled with this name in FIG. 4 is the top level node for this provider entity, which is a business that provides brake repair and muffler repair for customers who are typically members of the public. It should be kept in mind that, in many embodiments of the present invention, there will be a great many provider entities providing goods and services of all kinds, to the public, to other businesses, to governmental entities, and so on. Some of the provider entities may actually be agencies of a government (for example, a state department of motor vehicles). Also, as will be discussed, below, an entity that usually acts as a provider entity may also sometimes act as a customer entity. In this example, Ann's Auto Repair is primarily a provider entity.

As shown in FIG. 4, there are seven nodes representing Ann's Auto Repair at varying levels of granularity: (i) the top level Ann's Auto Repair corporation level node; (ii) a node for the brake repair department; (iii) a node for the muffler repair department; (iv) a node for Employee A (who works in the brake repair department); (v) a node for Employee B (who also works in the brake repair department; (vi) a node for Employee C (who works in the muffler repair department); and (vii) a node for Employee D (who works in the muffler repair department. Even though the entirety of graph 400 is not hierarchical (that is, in the manner of a tree data structure), the seven nodes representing Ann's Auto Repair are hierarchical. More specifically, the top level node has two child nodes (brake repair department and muffler repair department), and each of those child nodes has two nodes of its own (representing the four (4) employees of Ann's Auto Repair. This is a reflection of the fact that most business, or business like entities (for example, charities), have a hierarchical structure as they are implemented in the “real world.”

To focus on the specifics of setting up the provider entity portion of graph 400: (i) the seven (7) nodes are based on input from Ann's Auto Repair that is received from client sub-system 104 through communication network 114 (see FIG. 1); (ii) the seven (7) nodes are inserted into graph data structure 400 by provider side sub-mod 304 of mod 302; (iii) the hierarchical connections among and between the seven (7) nodes are based on input from Ann's Auto Repair that is received from client sub-system 104 through communication network 114 (see FIG. 1); and (iv) the hierarchical connections among and between the seven (7) nodes are inserted into graph data structure 400 by provider side sub-mod 310 of mod 308.

Processing proceeds to operation S260, where customer side sub-mod 306 of mod 302 sets up customer nodes for customers of Ann's Auto Repair. In this example, the nodes are based on information received from client sub-system 104 through communication network 114. In this example, the four (4) customer nodes (see graph 400 of FIG. 4) are added before any transactions are monitored. In this example, these four customers are individuals and/or businesses that have done business with Ann's Auto Repair in the past. Alternative, customer nodes may be added later in the method. For example, if new transaction involved a new customer that had never transacted business with Ann's Auto Repair in the past, then that customer node would be added at the time the new transaction was added to the graph. But, in this simple example, the customers of Ann's Auto Repair are all added to the graph before any new transactions are monitored and memorialized. At the time of operation S260, in this particular example, the customers have no connections to any transactions, and, indeed, there would be no transaction nodes in graph 400 yet. Alternatively, past transactions of the various customers may be added to the graph at this juncture in the method, which would lead to customers being connected to the various historical transactions, which historical transaction nodes would also be connected to the various ones of the seven (7) provider entity nodes of Ann's Auto Repair.

Processing proceeds to operation S265, where information on a new transaction (called Transaction 1) is received from client sub-system 106, which is the computer dedicated to operations of the brake repair department at Ann's Auto Repair. More specifically, Customer 1 (see graph 400 at Customer 1 node) has just purchased a brake repair service (and parts) on her vehicle from Employee A of the brake repair department at Ann's Auto Repair. Employee C also assisted in the repair work, even though she works for a different department. Accordingly, the T1 node of graph 400 is created by new transaction sub-mod 307 of mod 302. While flow chart 250 only covers the addition of Transaction 1 to graph 400, the operations are repeated to add the following transactions also shown in FIG. 4: (i) Transaction 2 (T2) is a transaction where Customer 2 receives a refund from Employee B for some brake work that proved to be faulty; (ii) Transaction 3 (T3) is a transaction where Customer 1 (who is also a financial advisor of Ann's Auto Repair) and Customer 3 worked together to provide refinancing on the mortgage for Ann's Auto Repair building; and (iii) Transaction 4 (T4) where Customer 4 purchased a muffler (without any services attached) from the muffler repair department of Ann's Auto repair.

Processing proceeds to operation S270, where a visual graphic code is set up for the new Transaction 1. More specifically, quick response (QR) code mod 314 sets up a QR style code design for Transaction 1 and puts that data, or at least a link to that data, in the node for Transaction 1, as is shown in the transaction 1 node of graph 400. This visual code allows the transaction to be recognized and identified with the aid of a camera or scanner or the like. In this example, the visual graphic code, in addition to the dedicated QR code, includes human readable text that says: “Transaction 1.”

Processing proceeds to operation S275, where new transaction sub-mod 312 of mod 308 sets up the connections between: (i) the Transaction 1 node of graph 400 and the Customer 1 node of graph 400; (ii) the Transaction 1 node of graph 400 and the Employee A node of graph 400; and (iii) the Transaction 1 node of graph 400 and the Employee C node of graph 400. The connection is made directly with the Employee A and Employee C nodes because Employees A and C performed the brake repair that was the subject matter of Transaction 1. In this way, graph 400 will now connect the Transaction 1 directly to Employees A and C, but also indirectly to all seven (7) nodes of Ann's Auto Repair.

Processing proceeds to operation S280, where provider side sub-mod 310 of mod 308 connects, in graph 400, provider side entity nodes to new the transaction. A shown in FIG. 4, this type of connection operations has created edges between the respective transaction nodes and the associated provider side entities: (i) T1 and employees A and Employee C nodes; (ii) T2 and the Employee B node; (iii) T3 and the top level Ann's Auto Repair enterprise level node; and (iv) T4 and the muffler repair department node.

With respect to the mortgage re-fi of T3, it is noted that this business was conducted directly with the Chief Executive Officer of Ann's Auto Repair (namely, Ann herself), and this is the reason that the T3 node is connected to the top level provider entity node, as shown in FIG. 4. With respect to the muffler purchase T4, this node is connected to the department level node because none of the employees A, B, C and/or D provided any substantial services in connection with this transaction T4.

Returning focus now to T1, the new transaction T1 dealt with in flow chart 250, processing proceeds to operation S285, where a review of T1 by Customer 1 is received from client sub-system 108 (that is, Customer 1's smart phone in this example, through communication network 114 and by customer review mod 316. More specifically, when Customer 1's brake work was performed, Employees A and C printed an invoice for Customer 1 that included the visual code for the transaction (including the dedicated QR code for T1). Using this QR code and an app on her smart phone, Customer 1 can show that she was involved in T1 and mod 316 therefore allows her to write a review of T1 because her access to the QR code is strong evidence that she did indeed receive the brake repairs that form the subject matter of this transaction. While this embodiment focusses on customer reviews, the following sub-section may suggest other types of data that may be received from transaction participants who receive the QR code and make use of it to enter other data related to the transaction (for example, warranty terms).

Processing proceeds to operation S290, where customer review mod 316 inserts the customer's review into the T1 node of graph 400. In this example, this insertion takes the form of adding a link to node T1, with the link linking to a copy of the review, which is actually stored at client sub-system 110. Now the graph structure 400 can be used to locate the review, secure in the confidence that the data came from an actual participant in the transaction (in this case, Customer 1).

### III. Further Comments and/or Embodiments

A method according to an embodiment of the present invention for supporting hierarchical reviews for transactions includes the following operations (not necessarily in the following order): (i) monitors multiple transactions by multiple consumers interacting with a multiple providers to form a hierarchical record of the set of monitored transactions; (ii) maps the hierarchical record of the transactions into an encoded representation with an expiration date; (iii) provides support to allow each consumer to input a comment related to a selected transaction; (iv) responsive to receiving an input comment from a consumer related to the selected transaction, with this receipt occurring prior to the expiration date, inserting the received input comment into a hierarchical review of the plurality of transactions; (v) the encoded representation code includes a time, a location, a number of the plurality of consumers, a chain of interactions in the plurality of transactions, the expirations data, and a plurality of transaction relationships associating a transaction consumer with a transaction provider; (vi) the hierarchical record further comprises: (a) identifying a plurality of relationships established in the selected transaction (for example, car buying at a dealer), and (b) constructing a relationship hierarchy based on the established relationships, (vii) the relationship hierarchy includes: (a) a first relationship (for example, sales), and (b) a second relationship (for example, loan) different from the first relationship; and (viii) providing a visual representation of the relationship hierarchy.

Some embodiments of the present invention may include one, or more, of the following operations, features, characteristics and/or advantages: (i) includes the consumers point of view (POV); (ii) dynamically itemizes transactions for a business; (iii) stores business transactions in an encoding (for example, QR (quick response) code); (iv) includes the concept of aggregating reviews for all parties; (v) automatically generates and stores necessary information about the transactions in an encoding; (vi) includes showing the parties involved (for example, the number of people in a group and provides any “verification” in their context); (vii) includes showing the transactional relationships as a time-based hierarchy (for example, buying a car at a dealer, obtaining a loan from a bank, and getting license plates); organizational hierarchy is dynamically generated on a per user basis; (viii) merchant(s) dynamically generate an encoding on all transactions that took place with the party, thus allows for an aggregated, verified review between all party members; (ix) the review system shows the visual representation of the hierarchy that is encoded; (x) individuals do not perform manual recording; and/or (xi) includes generating dynamic review templates.

Some embodiments of the present invention may include one, or more, of the following operations, features, characteristics and/or advantages: (i) includes a review system for storing end to end micro-transactions for a given physical business transaction (for example, eating at a restaurant, purchasing a car, and/or setting up a birthday party); (ii) dynamically generates a review template, based on all transactions that occurred, and are stored in an encoding (for example, QR code); (iii) dynamically generates a verified review template with location, time, transactions, consumers, and/or expiration date stored in the encoding; (iv) includes verification of the user; (v) includes itemization of the transaction; (vi) collecting consumer information is not necessary; (vii) attaches/ties a consumers review using a transaction to verify the relevance of the review; (viii) interactions within the transaction, personal experiences, and human interactions are reviewed and rated; (ix) embodiments of the present invention are not limited to a product review; (x) a database is not needed to collect and store information about consumers or products; and/or (xi) stores all interactions in the form of digital code such that all interactions can be reviewed and rated.

Some embodiments of the present invention may include one, or more, of the following operations, features, characteristics and/or advantages: (i) a consumer can review the product irrespective of a sale or not; (ii) the consumer will only be allowed to review parts of transaction that are relevant (for example, interactions with salesman, etc.); (iii) the consumer review can have an optional expiration date to make sure that the review is relevant with the period of time; (iv) the consumer review is only performed on current products; (v) does not rely on a review entity; (vi) all transactions are verified by the merchant and a code is generated which can be used for writing a review without further need for verification; (vii) for each transaction engagement with a merchant, that transaction is added to the QR code, similar to a receipt; (viii) once all transactions are completed, all information including relationship of the transactions, are embedded; (ix) after scanning the QR code, the system will proceed to a review site, where reviewing can start; and/or (x) verification involving a third party is not necessary.

Some embodiments of the present invention may include one, or more, of the following operations, features, characteristics and/or advantages: (i) does not rely on a payment manager; (ii) a QR code is generated from the transaction when the merchant and consumer engages in a transaction; (iii) transaction reviewing begins when the consumer scans the QR code; (iv) focusses on organizing separate reviews from multiple consumers or a single consumer about the same “experience”; and/or (v) the “experience” itself can be a single transaction or be spread over multiple transactions.

Some embodiments of the present invention recognize the following facts, potential problems and/or potential areas for improvement with respect to the current state of the art: (i) QR (quick response) codes are used for many purposes including acting as a download link to apps and websites, authentication, adding new contacts, or learning the history of an item; (ii) QR codes can be customized to contain a chain of transactions that someone has participated and owned; (iii) when someone makes a purchase from an on-line store, the store will let the buyer provide a review of the product that was purchased based on the buyers identity; (iv) when consumers go to a restaurant, car dealership or an automotive shop, the consumer generally ends up reviewing the merchants service using an online app outside of the merchant; (v) there is not enough validation to determine whether the person providing review information is really a consumer that used the merchants service; (vi) often times, a consumer's memory may be spotty or inaccurate, which could make the review system very unreliable: (vii) a QR code is normally used to send a consumer to a merchant's website to review the merchants product; and/or (viii) on the merchants website, the merchants can ask the consumer to take a survey that generically covers most of the amenities about the merchants facility (for example, if the consumer stayed in a hotel, the merchants would ask the consumers opinion about the room, dining, gym, laundry and other amenities at the facility, even though the consumer may have not used any of them).

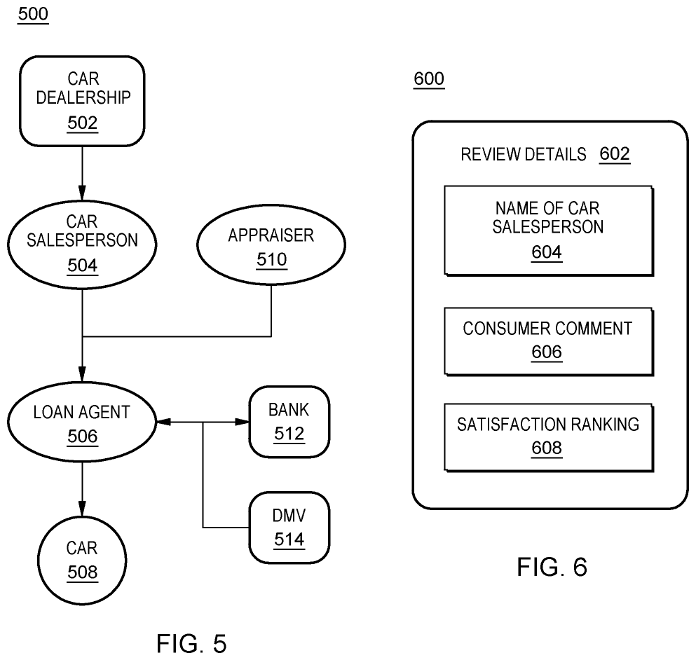

As shown in FIG. 5, diagram 500 shows the display of the transaction chain (that is, the various nodes of the graph) after visiting a car dealership by a consumer. The consumer can now pick any of the entities listed to review them. Diagram 500 includes: car dealership block 502; car salesperson block 504; loan agent block 506; car block 508; appraiser block 510; bank block 512; and DMV (department of motor vehicles) block 514.

As shown in FIG. 6, screenshot 600 shows a user interface for entering data related to a transaction, such as the transactions indicated by diagram 500. Screenshot 600 includes: review details 602; name of car salesperson block 604; consumer comment block 606; and satisfaction ranking block 608.

Some embodiments of the present invention may include one, or more, of the following operations, features, characteristics and/or advantages: (i) creates a chain of the transaction that belong to the consumer in the form of a code or QR code; (ii) when the consumer is ready to review, they will be presented with a hierarchal view of all the validated and verified transactions so that the transactions can now be reviewed; (iii) this will allow the consumer to only provide legitimate reviews on their experience; (iv) the QR code will store such things like: (a) time and location, (b) how many people in the group (split bill), (c) chain of transactions/interactions, (d) expiration date, and/or (e) transaction relationships; (v) the receipt from a merchants (for example, a restaurant) will store the receipt information in a QR code; (vi) when a consumer scans the QR code, it will take the consumer to a review site where it will pre-populate all the information, allowing review of all the items the consumer ordered, leaving no room for error and does not depend on the consumers recollection of what was ordered; and/or (vii) results can be displayed in a tree format for the user to visually see/review all entities.

Some embodiments of the present invention may include one, or more, of the following operations, features, characteristics and/or advantages: (i) embeds additional metadata like relationships of the transactions consumers are engaged in (for example, in QR code); (ii) uses QR code to display entity relationships in a transaction; (iii) includes the ability to review all entities of a transaction (for example, location, time, product, salesperson, and parties at the location); and/or (iv) includes business justification which is beneficial to social media companies and review systems.

Some embodiments of the present invention recognize the following facts, potential problems and/or potential areas for improvement with respect to the current state of the art: (i) when consumers purchase items from the store, each item gets itemized on the receipt; and/or (ii) additional metadata such as time of purchase, store location, and other information can also appear on the receipt.

Some embodiments of the present invention may include one, or more, of the following operations, features, characteristics and/or advantages: (i) there are a number of transactions on one QR code such as the process of purchasing a car, where multiple transactions take place (for example, interaction with the salesman, loan agent, cars driven, car purchased, DMV, etc.); (ii) each interaction and transaction is embedded into the QR code; (iii) when performing a review, the consumer can scan the QR code and he/she will be presented with a tree view of all entities that he/she is allowed to review; (iv) the QR code can be used by a group (for example, a group of people ordering family style in a restaurant) where each person will be able to submit a review of the restaurant, server, and/or food they ate independently; (v) the review system is smart enough to tie all the reviews together from a group and be presented under one transaction, providing different viewpoints of the consumers under the same setting(s); (vi) the review ties to a single transaction instead of incorrectly calculating it as multiple reviews of one experience; (vii) the QR code has an expiration date, which is usually mandated by the merchant; and/or (viii) typically, a merchant can set the review expiration time (for example, one month).

Some embodiments of the present invention may include one, or more, of the following operations, features, characteristics and/or advantages: (i) each merchant salesperson will have their own QR code that will be tracked across all review platforms; (ii) QR code standardization allows the guests and establishments to see how well their employees are performing, since many business owners have no insight into how their business is actually run; (iii) allows all interested parties to be able to filter down on things they are interested in as well as allow review systems to show more visualization and metrics; (iv) can be applied to many business transactions (for example, mechanic shops, retail shops, and even a farmers market); and/or (v) each receipt will tell the merchant how they performed on that transaction and help them improve and correct their problems.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant and data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a first provider entity data set that identifies: (i) a first provider entity; and (ii) a plurality of sub-entities that are respectively considered as portions of the first provider entity;
creating a first provider portion of a first graph data structure, with the first provider portion of the first graph data structure including: (i) a root level node corresponding to the first provider entity, (ii) lower level nodes respectively corresponding to the sub-entities of the first provider entity, and (iii) hierarchical connections among and between the root level node and the lower level nodes so that the first provider portion of the first graph forms a tree structure;
creating a first customer entity node in the first graph data structure;
receiving a new transaction data set including information indicative of a business transaction between the first customer entity and a first provider sub-entity of the plurality of sub-entities;
creating a new transaction node in the first graph data structure, with the new transaction node including data from the first new transaction data set;
creating a pairwise connection in the first graph data structure between the new transaction node and the lower level node corresponding to the first provider sub-entity; and
creating a pairwise connection in the first graph data structure between the new transaction node and the first customer entity node.

2. The CIM of claim 1 further comprising:
creating a first visual graphic code that identifies the first new transaction; and
inserting the first visual graphic code into the first new transaction node by at least one of the following techniques: a link and/or inclusion of the first visual graphic code with other data of the first new transaction code.

3. The CIM of claim 2 wherein the creation of the first visual graphic code includes generation of a quick response (QR) code identifying the first new transaction.

4. The CIM of claim 3 further comprising:
using, by the first customer entity of the first new transaction, the QR code to authenticate the first customer entity as a participant in the first new transaction; and
subsequent to authentication of the first customer entity using the QR code, receiving from the first customer entity and over a communication network, a piece of content in the form of a customer review relating to the first new transaction.

5. The CIM of claim 3 further comprising:
using, by an entity participating the first new transaction, the first visual graphic code to authenticate the entity as a participant in the first new transaction; and
subsequent to authentication of the customer entity using the first visual graphic code, receiving from the entity and over a communication network, a piece of content relating to the first new transaction.

6. The CIM of claim 5 wherein the entity is one of the following: the first provider entity or one of the plurality of sub-entities of the first provider entity.

7. A computer program product (CPP) comprising:
a set of storage device(s); and
computer code stored collectively in the set of storage device(s), with the computer code including data and instructions to cause a processor(s) set to perform at least the following operations:
receiving a first provider entity data set that identifies: (i) a first provider entity; and (ii) a plurality of sub-entities that are respectively considered as portions of the first provider entity,
creating a first provider portion of a first graph data structure, with the first provider portion of the first graph data structure including: (i) a root level node corresponding to the first provider entity, (ii) lower level nodes respectively corresponding to the sub-entities of the first provider entity, and (iii) hierarchical connections among and between the root level node and the lower level nodes so that the first provider portion of the first graph forms a tree structure,
creating a first customer entity node in the first graph data structure,
receiving a new transaction data set including information indicative of a business transaction between the first customer entity and a first provider sub-entity of the plurality of sub-entities,
creating a new transaction node in the first graph data structure, with the new transaction node including data from the first new transaction data set,
creating a pairwise connection in the first graph data structure between the new transaction node and the lower level node corresponding to the first provider sub-entity, and
creating a pairwise connection in the first graph data structure between the new transaction node and the first customer entity node.

8. The CPP of claim 7 wherein the computer code further includes instructions for causing the processor(s) set to perform the following operation(s):
creating a first visual graphic code that identifies the first new transaction; and
inserting the first visual graphic code into the first new transaction node by at least one of the following techniques: a link and/or inclusion of the first visual graphic code with other data of the first new transaction code.

9. The CPP of claim 8 wherein the creation of the first visual graphic code includes generation of a quick response (QR) code identifying the first new transaction.

10. The CPP of claim 9 wherein the computer code further includes instructions for causing the processor(s) set to perform the following operation(s):
using, by the first customer entity of the first new transaction, the QR code to authenticate the first customer entity as a participant in the first new transaction; and
subsequent to authentication of the first customer entity using the QR code, receiving from the first customer entity and over a communication network, a piece of content in the form of a customer review relating to the first new transaction.

11. The CPP of claim 9 wherein the computer code further includes instructions for causing the processor(s) set to perform the following operation(s):
using, by an entity participating the first new transaction, the first visual graphic code to authenticate the entity as a participant in the first new transaction; and
subsequent to authentication of the customer entity using the first visual graphic code, receiving from the entity and over a communication network, a piece of content relating to the first new transaction.

12. The CPP of claim 11 wherein the entity is one of the following: the first provider entity or one of the plurality of sub-entities of the first provider entity.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving a first provider entity data set that identifies: (i) a first provider entity; and (ii) a plurality of sub-entities that are respectively considered as portions of the first provider entity,
creating a first provider portion of a first graph data structure, with the first provider portion of the first graph data structure including: (i) a root level node corresponding to the first provider entity, (ii) lower level nodes respectively corresponding to the sub-entities of the first provider entity, and (iii) hierarchical connections among and between the root level node and the lower level nodes so that the first provider portion of the first graph forms a tree structure,
creating a first customer entity node in the first graph data structure,
receiving a new transaction data set including information indicative of a business transaction between the first customer entity and a first provider sub-entity of the plurality of sub-entities,
creating a new transaction node in the first graph data structure, with the new transaction node including data from the first new transaction data set,
creating a pairwise connection in the first graph data structure between the new transaction node and the lower level node corresponding to the first provider sub-entity, and
creating a pairwise connection in the first graph data structure between the new transaction node and the first customer entity node.

14. The CS of claim 13 wherein the computer code further includes instructions for causing the processor(s) set to perform the following operation(s):
creating a first visual graphic code that identifies the first new transaction; and
inserting the first visual graphic code into the first new transaction node by at least one of the following techniques: a link and/or inclusion of the first visual graphic code with other data of the first new transaction code.

15. The CS of claim 14 wherein the creation of the first visual graphic code includes generation of a quick response (QR) code identifying the first new transaction.

16. The CS of claim 15 wherein the computer code further includes instructions for causing the processor(s) set to perform the following operation(s):
using, by the first customer entity of the first new transaction, the QR code to authenticate the first customer entity as a participant in the first new transaction; and
subsequent to authentication of the first customer entity using the QR code, receiving from the first customer entity and over a communication network, a piece of content in the form of a customer review relating to the first new transaction.

17. The CS of claim 15 wherein the computer code further includes instructions for causing the processor(s) set to perform the following operation(s):
using, by an entity participating the first new transaction, the first visual graphic code to authenticate the entity as a participant in the first new transaction; and
subsequent to authentication of the customer entity using the first visual graphic code, receiving from the entity and over a communication network, a piece of content relating to the first new transaction.

18. The CS of claim 17 wherein the entity is one of the following: the first provider entity or one of the plurality of sub-entities of the first provider entity.
